(19) United States
(12) Patent Application Publication
(10) Pub. No.: US 2025/0076210 A1
(43) Pub. Date: Mar. 6, 2025

(54) DISPLAYING MULTI-STAGE NDT ANALYTIC INFORMATION

(71) Applicant: Baker Hughes Holdings LLC, Houston, TX (US)

(72) Inventors: Kevin Coombs, Syracuse, NY (US); Sheldon McCrackin, Yukon, OK (US)

(21) Appl. No.: 18/459,936

(22) Filed: Sep. 1, 2023

(51) Int. Cl. G01N 21/88; G06F 3/01; G06T 7/00; G06V 10/44; H04N 5/265

(52) U.S. Cl. CPC G01N 21/8851; G06F 3/016; G06T 7/0008; G06V 10/44; H04N 5/265; G06V 2201/07

(57) ABSTRACT

A first set of data characterizing an image or video captured by a non-destructive testing device from within mechanical equipment during an inspection, and a second set of data characterizing an image recognition library that includes features of example mechanical equipment is received. A presence of a feature is determined based on the first set of received data and the second set of received data. An indication of a presence of the feature is provided.

### TECHNICAL FIELD

This disclosure relates to user interfaces of non-destructive testing devices.

### BACKGROUND

Video inspection devices, such as video endoscopes or borescopes, can be used to take depth measurements on an object (e.g., lowest points in anomalies such as pits or dents, heights of welds, measurements of offsets or clearances between surfaces, etc.). Additionally, video inspection devices can be used to observe defects (e.g., tears, cracks, scratches, etc.) on a surface of an object (e.g., an industrial machine). In many instances, the surface of the object is inaccessible and cannot be viewed without the use of the video inspection device. For example, a video inspection device can be used to inspect the surface of a blade of a turbine engine on an aircraft or power generation unit to identify any anomalies to determine if any repair or further maintenance is required. In order to make that assessment, it is often necessary to obtain highly accurate-dimensional measurements of the surface to verify that the anomaly does not fall outside an operational limit or required specification for that object.

### SUMMARY

This disclosure relates to displaying multi-stage non-destructive testing device analytic information.

An example implementation of the subject matter described within this disclosure is a method with the following features. A first set of data characterizing an image or video captured by a non-destructive testing device from within mechanical equipment during an inspection, and a second set of data characterizing an image recognition library that includes features of example mechanical equipment is received. A presence of a feature is determined based on the first set of received data and the second set of received data. An indication of a presence of the feature is provided.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example method, which can be combined with the example method alone or in combination with other aspects, include the following. Providing the indication includes displaying a flashing border on a graphical user interface displayed, with the image or video, on display screen.

Aspects of the example method, which can be combined with the example method alone or in combination with other aspects, include the following. Providing the indication can include emitting an audible signal to a user and/or providing haptic feedback to the user.

Aspects of the example method, which can be combined with the example method alone or in combination with other aspects, include the following. A user input indicative of a request to see more details is received. A location of the feature present within the image or video is determined. The image or video is displayed upon a display screen. A graphical object overlaid onto the image or video is displayed. The graphical object is overlaid to indicate a portion of the image or video containing the feature.

Aspects of the example method, which can be combined with the example method alone or in combination with other aspects, include the following. The user input can include an input on a touch screen, a voice command, or a press of an electromechanical switch.

Aspects of the example method, which can be combined with the example method alone or in combination with other aspects, include the following. The user input is a first user input. The graphical object is a first graphical object. The method further includes the following features. A second user input indicative of a request to see more details is received. A type of feature present within the image or video is determined. A second graphical object overlaid onto the image or video is displayed. The second graphical object is overlaid onto the image or video adjacent to the first graphical object. The second graphical object is configured to convey the determined type of feature to a user.

Aspects of the example method, which can be combined with the example method alone or in combination with other aspects, include the following. A third a user input acknowledging the determined location of the feature and the determined type of feature is received. The determined location of the feature and the determined type of the feature are saved. The image or video is displayed without the first graphical object or the second graphical object.

Aspects of the example method, which can be combined with the example method alone or in combination with other aspects, include the following. A third user input indicative that the determined location or the determined type are to be changed is received. The determined location or the determined type is updated. The updated determined location or the determined type is provided.

Aspects of the example method, which can be combined with the example method alone or in combination with other aspects, include the following. Receiving the first set of data and the second set of data includes receiving the first set of data and the second set of data by a borescope.

Aspects of the example method, which can be combined with the example method alone or in combination with other aspects, include the following. The feature is a defect.

Aspects of the example method, which can be combined with the example method alone or in combination with other aspects, include the following. The mechanical equipment includes a compressor, a turbine, a conduit, a pump, or a pressure vessel.

### BRIEF DESCRIPTION OF DRAWINGS

These and other features will be more readily understood from the following detailed description taken in conjunction with the accompanying drawings.

FIG. 1 is a flowchart of an example method that can be used with aspects of this disclosure.

FIG. 2 is an example image of a gas turbine blade with an example overlaid graphical user interface.

FIG. 3 is an example image of a gas turbine blade with a defect with a flashing border overlaid with the graphical user interface.

FIG. 4 is the image of FIG. 3 with a graphical object indicating a location of the defect.

FIG. 5 is the image of FIG. 4 with a graphical object indicating a potential type or category of the defect.

FIG. 6 is the image of FIG. 5 with a graphical object indicating that the potential type or category of the defect has been accepted by a user.

FIG. 7 is a block diagram of an example controller that can be used with aspects of this disclosure.

FIG. 8 is an example borescope that can be used with aspects of this disclosure.

### DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

During inspection operations, it can be easy to overlook defects displayed upon a screen. Efforts to automatically detect and highlight defects on a screen can result in a user conducting an inspection becoming frustrated, confused, or unable to complete an adequate inspection due to graphical objects crowding a screen that is meant to display components for inspection.

This disclosure describes a Graphical User Interface (GUI) that is able to display information about detected features that may be of interest to a user in stages. A first stage alerts the user that a feature of interest, such as a defect, is present within the present view. A second stage highlights the feature of interest, and a third stage provides a possible label, type, or category of the feature of interest. The user is then able to annotate, accept, or alter the provided location and/or type of feature before clearing the screen of the excess graphical objects and continuing the inspection.

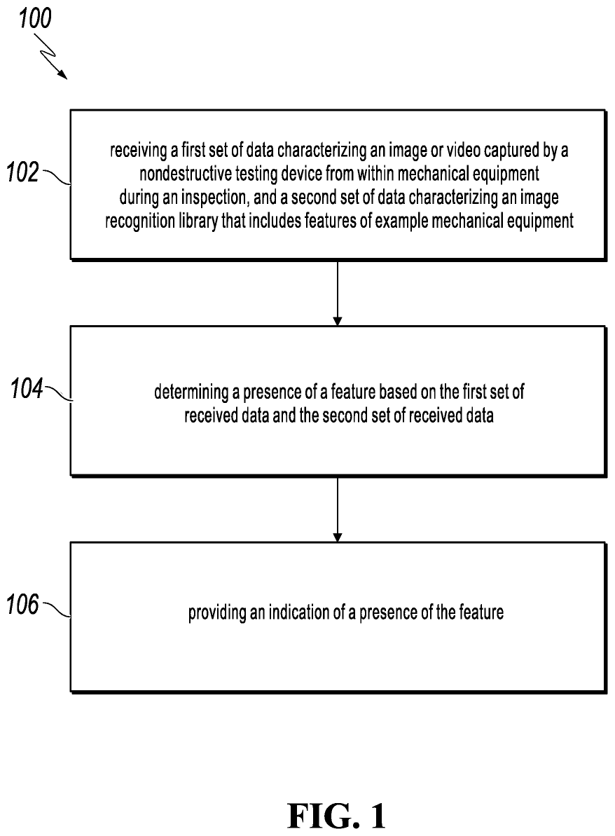

FIG. 1 is a flowchart of an example method 100 that can be used with aspects of this disclosure. At 102 a first set of data and a second set of data are received. The first set of data characterizes an image or video captured by a non-destructive testing (NDT) device from within mechanical equipment during an inspection, and the second set of data characterizes an image recognition library that includes features of example mechanical equipment. In some implementations, the mechanical equipment can include a compressor, a turbine, a conduit, a pump, a pressure vessel, a heat exchanger or any other mechanical equipment subjected to non-destructive testing. In some embodiments, the first set of data and/or the second set of data can be received by a non-destructive testing device, for example a borescope.

At 102, a presence of a feature is determined based on the first set of received data and the second set of received data. For example, in some implementations, such a feature can include a defect, such as a chip or nick in a turbine blade.

At 104, an indication of a presence of the feature is provided. In some implementations, such an indication can be provides as a flashing border on a graphical user interface displayed, with the image or video, on display screen. In some implementations, such an indication can include emitting an audible signal to a user or providing haptic feedback to the user. In such circumstances, the NDT device can be equipped with a speaker and/or a motorized oscillating weight.

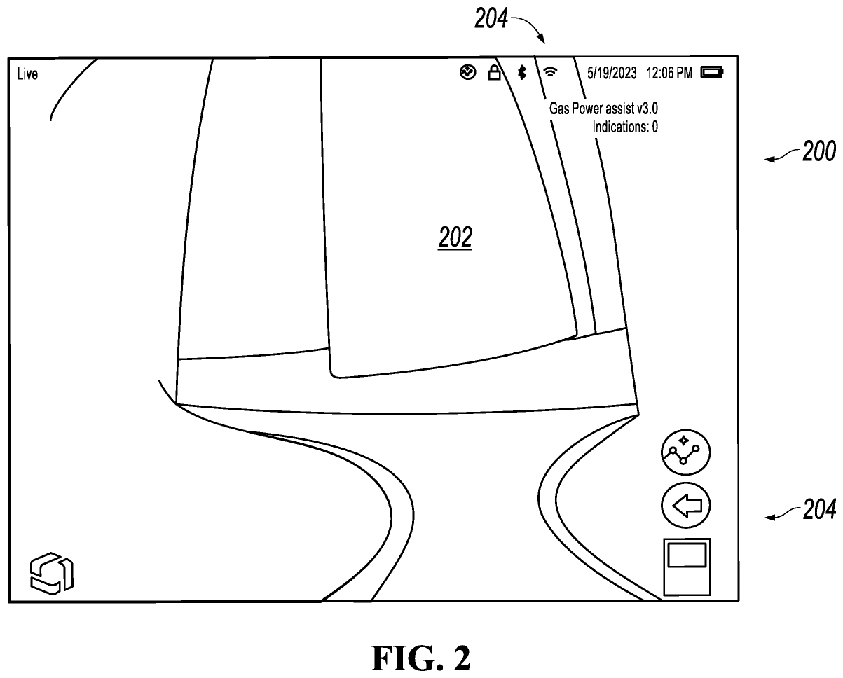

FIGS. 2-6 illustrated a series of screen-shots demonstrating an inspection that can use aspects of the method 100. Starting at FIG. 2, an example image 200 of a gas turbine compressor blade 202 is displayed with an example graphical user interface (GUI) 204 overlaid on the image 200. While the examples described herein primarily describe inspections in the context of gas turbine compressor blades 202, aspects described within this disclosure are similarly applicable to other mechanical systems described throughout this disclosure. The GUI 204 can include status indicators, such as Wi-Fi or Bluetooth connectivity, battery life, time and date, as well as other indications. Alternatively or in addition, the GUI 204 can include a software version. In the present GUI 204 includes user interfaces that are hidden or greyed out to indicate that they are not currently available to the user.

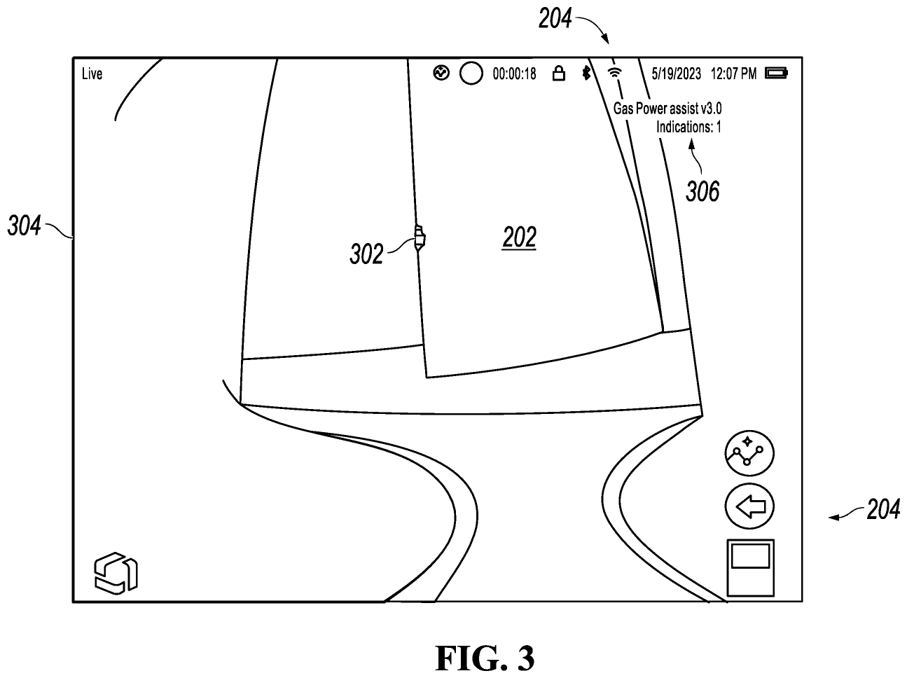

During the example inspection, the compressor section is rotates so that multiple compressor blades 202 can be inspected. In instances where a feature, such as a defect 302 enters view, as shown in FIG. 3. Once the defect 302 is in view, a flashing border 304 is overlaid with the GUI 204. In some implementations, the GUI 204 can also include a graphical object 306 that indicates a count of defects in view. In some instances, multiple defects can be in a given view. In such instances, the flashing border 304 can maintain a same behavior as when a single defect is in view. Alternatively, a frequency or color of the flashing border 304 can be indicative of the number or type of defects visible. Alternatively or in addition, other indications can be provided to a user that a defect 302 is displayed in the present field of view. Such indications can include haptic feedback or an audible indication. The general warning presented by these indications allows the user to continue the inspection without the image being crowded with graphical objects that can interfere with the user's ability to assess and inspect.

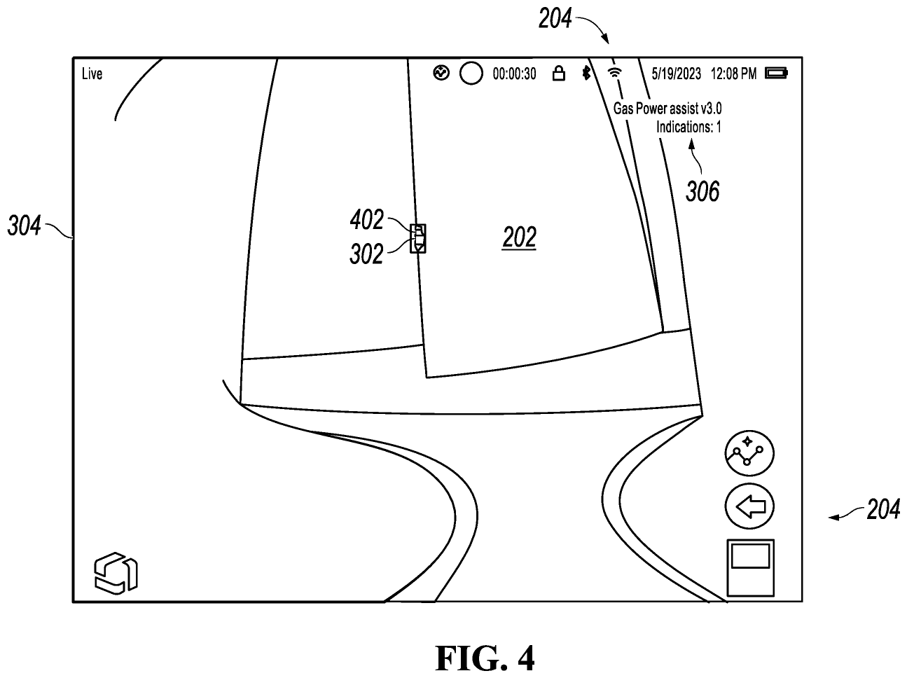

In some instances, the user wants to further assess the defect. In such instances, the NDT device can receive a user input indicative of a request to see more details. Such a user input can include, for example, an input on a touch screen, a voice command, or a press of an electromechanical switch. Once the request has been received, a location of the feature within the displayed image or video is determined, for example, by a processor (described later). In some implementations, the determination can have been made prior to the request. After a determination has been made, as shown in FIG. 4, a graphical object 402 indicating a location of the defect 302 is overlaid onto a portion of the image or video containing the defect 302. In the illustrated example, a rectangle outlines the defect 302.

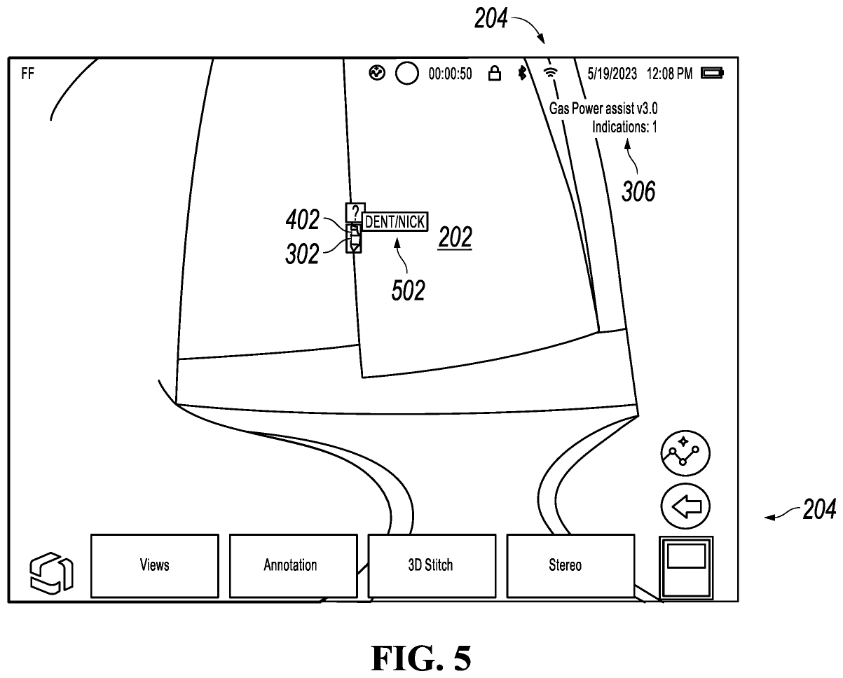

In instances where the user would like further information, for example, what type of defect 302 is highlighted, the NDT device can receive a second user input indicative of a request to see more details. Once the second request has been received, a type, category, or label of the defect 302 present within the image or video can be determined. In some implementations, the determination can have been made prior to the request. After the type of defect has been determined, as shown in FIG. 5, a second graphical object 502 can be displayed and overlaid onto the image or video. The second graphical object 502 being overlaid onto the image or video adjacent to the first graphical object 402 highlighting the defect 302. The second graphical object 502 is configured to convey the determined type of feature to a user, for example, by displaying a label.

In some implementations, additional graphical objects indicative of selectable options can be displayed. For example, in some implementations, a third user input can be received. Such a user input can be indicative that the current image is to be annotated, that a view of the current image is to be changed, or that the determined location highlighted by the first graphical object 402 is to be changed, or that the determined type, indicated by the second graphical object, is to be changed. For example a user could update the second graphical object to indicate that a crack was present instead of a dent/nick. Such updates can be saved to a non-transitory memory to update updating the determined location and/or the determined type of the defect. The updates can then be provided, for example, to the display or to a database.

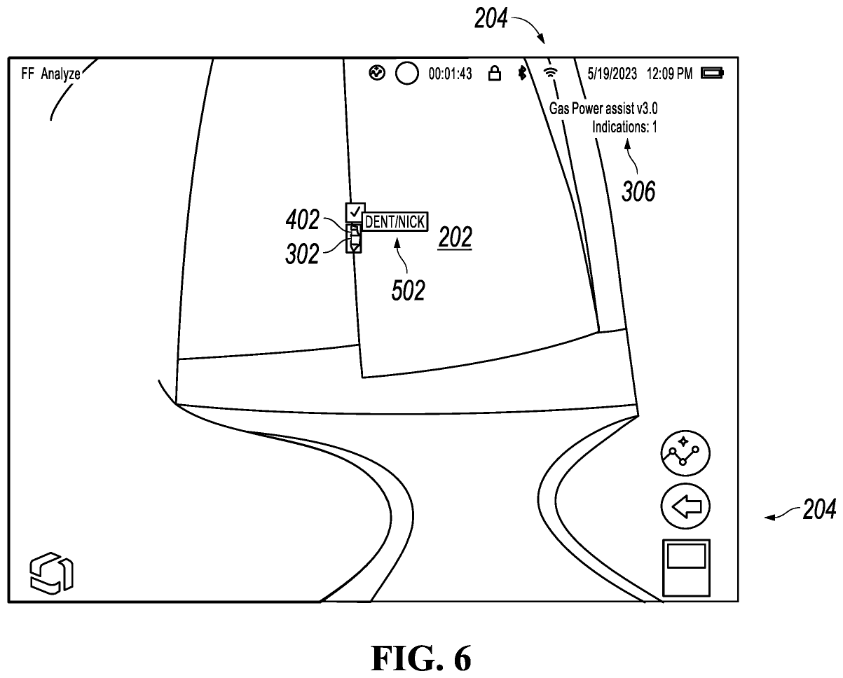

In some instances, such as shown in FIG. 6, the type or location of the defect has can be accepted by the user. In such an instance, a third user input acknowledging the determined location of the feature and the determined type of feature is received. In response to the user input, the determined location of the feature and the determined type of the feature are saved, for example, to a non-transitory memory. Once the location and type have been saved, the inspection can continue, and the image or video can be displayed without the first graphical object 402 or the second graphical object 502.

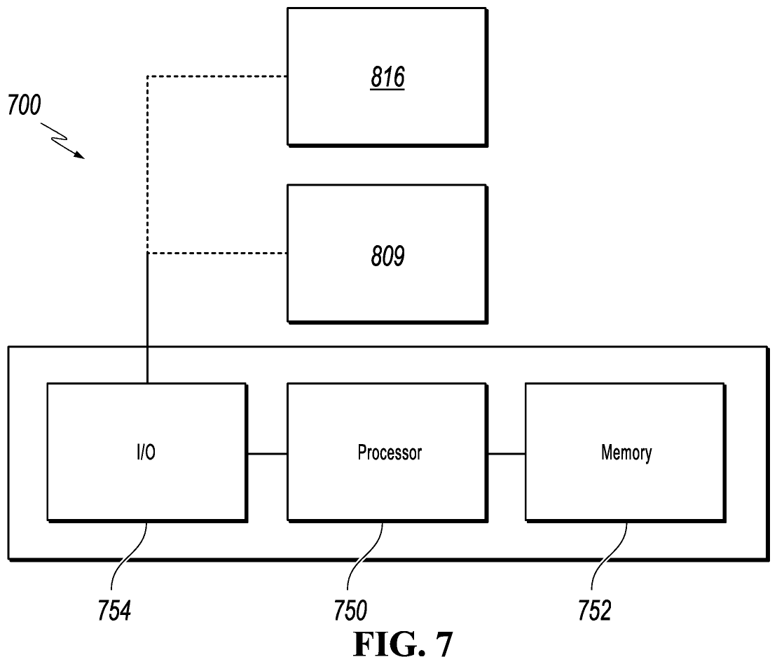

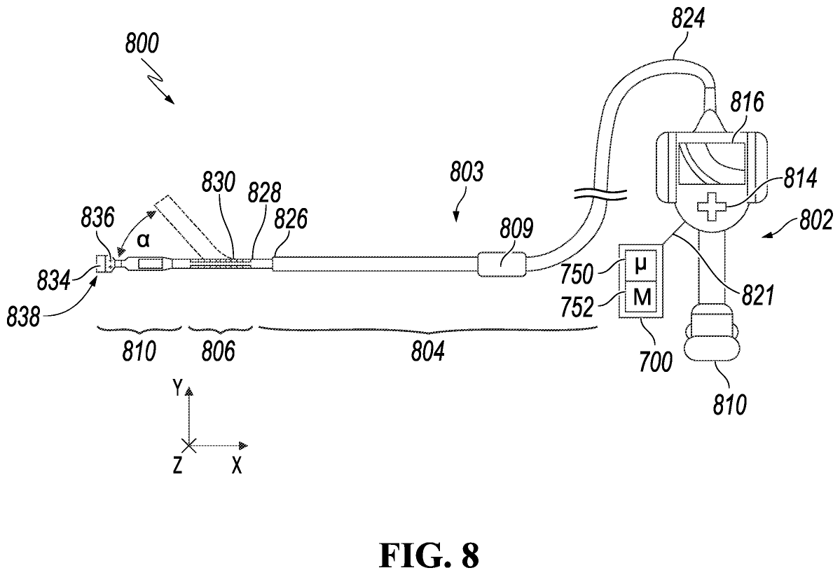

FIG. 7 illustrates the example controller 700 that can be used with some aspects of the current subject matter. For example, in some embodiments, the controller can execute all or part of the method 100 described throughout within this disclosure. The controller 700 can, among other things, monitor parameters of a system, send signals to actuate and/or adjust various operating parameters of such systems. As shown in FIG. 7, the controller 700 can include one or more processors 750 and non-transitory computer readable memory storage (e.g., memory 752) containing instructions that cause the processors 750 to perform operations. The processors 750 are coupled to an input/output (I/O) interface 754 for sending and receiving communications with components in the system, including, for example, the screen 816 and/or the driver 809 (FIG. 8). In certain instances, the controller 700 can additionally communicate status with and send actuation and/or control signals to one or more of the various system components (including, for example, a light source) of the system, as well as other sensors (e.g., pressure sensors, temperature sensors, vibration sensors and other types of sensors) that provide signals to the system.

FIG. 8 is a diagram illustrating an exemplary embodiment of an inspection device (e.g., a non-destructive device) in the form of a borescope 800 that can be used with aspects of this disclosure. The borescope 800 can include a control unit 802 and an inspection tube 803. The inspection tube 803 can include a conduit section 804, a bendable, actuable articulation portion or section 806, and an inspection head 808. In one embodiment, the sections 804, 806, 808 can have different lengths and can be integral with one another, or can be detachable from one another. As depicted, the conduit section 804 is suitable for insertion into a variety of different targets, such as inside turbomachinery, equipment, pipes, conduits, underwater locations, curves, bends, inside or outside of an aircraft system, and the like.

The borescope 800 can include a probe driver 809 coupled to the conduit section 804. The probe driver 809 can include actuators (not shown) configured to translate and/or rotate one or more of the sections 804, 806, 808 (e.g., to facilitate insertion of the inspection head 808 into the target). Additionally or alternatively, orientation/position of a portion of the inspection head 808 (e.g., camera, light source, etc.) can be varied to acquire an inspection region image (e.g., RGB image, IR image, etc.). The control unit 802 can include a control unit housing 810, a controller 700, a directional input 814, and a screen 816. The controller 700 can include a processor 750 and a readable memory 752 containing computer readable instructions which can be executed by the processor 750 in order to actuate the borescope 800. The computer readable instructions can include an inspection plan based on which the borescope 800 or a portion thereof (e.g., a conduit section 804, a bendable articulation section 806, and an inspection head 808) can be translated/rotated (e.g., by the probe driver 809). In some implementations, the operation of the probe driver 809 can be based on a control signal (e.g., generated by the controller 500 based on the inspection plan/user input via GUI display space on screen 816 or a computing device, etc.).

The controller 700 can be communicatively coupled to the control unit 802 via one or more cables 821. The controller 700 can also be arranged within the control unit housing 810, or can be arranged outside the control unit housing 810. On some implementations, the directional input 814 can be configured to receive user input (e.g., direction controls) to the control unit 802 for actuation of the borescope 800. The screen 816 can display visual information being received by the camera (including an optical sensor) arranged in the inspection head 808, which can allow the user to better guide the borescope 800 using the directional input 814. The directional input 814 and the screen 816 can be communicatively coupled to the controller 700 via the one or more cables 821, which can be a hard-wired connection or a wireless signal, such as WI-FI or Bluetooth. In one implementation, inspection data and/or notifications (e.g., notifications based on inspection data as described above) can be provided on the screen 816. More details on the controller 700 are described later in this disclosure.

The conduit section 804 can include a tubular housing 822 including a proximal end 824 and a distal end 826. The tubular housing 822 can be a flexible member along its whole length, or can be rigid at the proximal end 824 and become more flexible travelling down the length of the conduit section 804 towards the distal end 826. In certain embodiments, the tubular housing 822 can be formed from a non-porous material to prevent contaminants from entering the borescope 800 via the conduit section 804.

The control unit 802 can be arranged at the proximal end 824 of the tubular housing 822, and the bendable articulation section 806 can be arranged at the distal end of the tubular housing 822. The bendable articulation section 806 can include a bendable neck 828 and washers 830. The bendable neck 828 can be arranged at the distal end 826 of the tubular housing 822, and is able to be actuated 360° in the Y-Z plane. The bendable neck 828 can be wrapped in a non-porous material to prevent contaminants from entering the borescope 800 via the bendable articulation section 806.

The inspection head 808 can include a light source 834 (e.g., LEDs or a fiber optic bundle with lights at the proximal end), a camera 836 (or multiple cameras such as visible-light camera, IR camera, etc.), and one or more sensors 838 that can be configured to collect data about the surrounding environment. Details about example sensors 838 are described later within this disclosure. The camera 836 of the borescope 800 can provide images and video suitable for inspection to the screen 816 of the control unit 802. The light source 834 can be used to provide for illumination when the inspection head 808 is disposed in locations having low light or no light. The sensor 838 can record data including temperature data, distance data, clearance data (e.g., distance between a rotating element and a stationary element), flow data, and so on.

In certain embodiments, the borescope 800 includes one or more replacement inspection heads 108. The inspection head 808 can include tips having differing optical characteristics, such as focal length, stereoscopic views, 3-dimensional (3D) phase views, shadow views, etc. Additionally or alternatively, the inspection head 808 can include a removable and replaceable portion of the inspection head 808. Accordingly, the head sections 108, bendable necks 828, and conduit section 804 can be provided at a variety of diameters from approximately one millimeter to ten millimeters or more.

During use, the bendable articulation section 806 and the probe driver 809 can be controlled, for example, by the control inputs (e.g., relative control gestures, physical manipulation device) from the directional input 814 and/or control signals generated by the controller 700. The directional input can be a joystick, D-pad, touch pad, trackball, optical sensor, or a touchscreen over the screen 816. The directional input 814 can also be a similar device that is located outside the control unit housing 810 and connected by wire or wireless means. In particular, a set of control inputs can be used to control the bendable articulation section 806 and/or the probe driver 809. The bendable articulation section 806 can steer or “bend” in various dimensions, while the conduit section 804 can translate and/or rotate, using any combination of actuators and wires arranged within the control unit 802, to adjust the orientation (e.g., a positioning) of the inspection head 808. In some implementations, the control inputs/direction input 814 can be generated by the controller based on an inspection plan.

The actuators can be electric, pneumatic, or ultrasonically operated motors or solenoids, shape alloy, electroactive polymers, dielectric elastomers, polymer muscle material, or other materials. For example, the bendable articulation section 806 and the probe driver 809 can enable movement of the inspection head 808 in an X-Y plane, X-Z plane, and/or Y-Z plane. Indeed, the directional input 814 can be used to perform control actions suitable for disposing the inspection head 808 at a variety of angles, such as the depicted angle α. In this manner, the inspection head 808 can be positioned to visually inspect desired locations.

Once the inspection head 808 is in a desired position, the camera 836 can operate to acquire, for example, a stand-still visual image or a continuous visual image, which can be displayed on the screen 816 of the control unit 802, and can be recorded by the borescope 800. In embodiments, the screen 816 can be multi-touch touch screens using capacitance techniques, resistive techniques, infrared grid techniques, and the like, to detect the touch of a stylus and/or one or more human fingers. Additionally or alternatively, acquired visual images can be transmitted into a separate storage device for later reference.

In some embodiments, source code can be human-readable code that can be written in program languages such as python, C++, etc. In some embodiments, computer-executable codes can be machine-readable codes that can be generated by compiling one or more source codes. Computer-executable codes can be executed by operating systems (e.g., linux, windows, mac, etc.) of a computing device or distributed computing system. For example, computer-executable codes can include data needed to create runtime environment (e.g., binary machine code) that can be executed on the processors of the computing system or the distributed computing system.

Other embodiments are within the scope and spirit of the disclosed subject matter. For example, the method of generating consolidate dataset described in this application can be used in facilities that have complex machines with multiple operational parameters. Usage of the word “optimize”/“optimizing” in this application can imply “improve”/“improving.”

Certain embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a Read Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back end component (e.g., a data server), a middleware component (e.g., an application server), or a front end component (e.g., a client computer having a graphical user interface or a web interface through which a user can interact with an embodiment of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

1. A method comprising:
receiving a first set of data characterizing an image or video captured by a non-destructive testing device from within mechanical equipment during an inspection, and a second set of data characterizing an image recognition library that includes features of example mechanical equipment;
determining a presence of a feature based on the first set of received data and the second set of received data; and
providing an indication of a presence of the feature.

2. The method of claim 1, wherein providing the indication comprises displaying a flashing border on a graphical user interface displayed, with the image or video, on display screen.

3. The method of claim 1, wherein providing the indication comprises:
emitting an audible signal to a user; or
providing haptic feedback to the user.

4. The method of claim 1, further comprising:
receiving a user input indicative of a request to see more details;
determining a location of the feature present within the image or video;
displaying the image or video upon a display screen; and
displaying a graphical object overlaid onto the image or video, the graphical object being overlaid to indicate a portion of the image or video containing the feature.

5. The method of claim 4, wherein the user input comprises an input on a touch screen, a voice command, or a press of an electromechanical switch.

6. The method of claim 4, wherein the user input is a first user input, wherein the graphical object is a first graphical object, the method further comprising:
receiving a second user input indicative of a request to see more details;
determining a type of feature present within the image or video; and
displaying a second graphical object overlaid onto the image or video, the second graphical object being overlaid onto the image or video adjacent to the first graphical object, the second graphical object configured to convey the determined type of feature to a user.

7. The method of claim 6, further comprising:
receiving third a user input acknowledging the determined location of the feature and the determined type of feature;
saving the determined location of the feature and the determined type of the feature; and
displaying the image or video without the first graphical object or the second graphical object.

8. The method of claim 6, further comprising:
receiving a third user input indicative that the determined location or the determined type are to be changed;
updating the determined location or the determined type; and
providing the updated determined location or the determined type.

9. The method of claim 1, wherein receiving the first set of data and the second set of data comprises receiving the first set of data and the second set of data by a borescope.

10. The method of claim 1, wherein the feature is a defect.

11. The method of claim 1, wherein the mechanical equipment comprises a compressor, a turbine, a conduit, a pump, or a pressure vessel.

12. A system comprising:
at least one data processor; and
non-transitory memory storing instructions, which, when executed by the at least one data processor causes the at least one data processor to perform operations comprising:
receiving a first set of data characterizing an image or video captured by a non-destructive testing device from within mechanical equipment during an inspection, and a second set of data characterizing an image recognition library that includes features of example mechanical equipment;
determining a presence of a feature based on the first set of received data and the second set of received data; and
providing an indication of a presence of the feature.

13. The system of claim 12, wherein providing the indication comprises displaying a flashing border on a graphical user interface displayed, with the image or video, on display screen.

14. The system of claim 12, wherein providing the indication comprises:
emitting an audible signal to a user; or
providing haptic feedback to the user.

15. The system of claim 12, wherein the operations further comprise:
receiving a user input indicative of a request to see more details;
determining a location of the feature present within the image or video;
displaying the image or video upon a display screen; and
displaying a graphical object overlaid onto the image or video, the graphical object being overlaid to indicate a portion of the image or video containing the feature.

16. The system of claim 15, wherein the user input comprises an input on a touch screen, a voice command, or a press of an electromechanical switch.

17. The system of claim 12, wherein the operations further comprise:
receiving a second user input indicative of a request to see more details;
determining a type of feature present within the image or video; and
displaying a graphical object overlaid onto the image or video, the second graphical object being overlaid onto the image or video, the graphical object configured to convey the determined type of feature to a user.

18. The system of claim 12, wherein the operations further comprise:
receiving a third user input acknowledging a determined location of the feature and a determined type of feature;
saving the determined location of the feature and the determined type of the feature; and
displaying the image or video without the first graphical object of the second graphical object.

19. The system of claim 12, wherein the operations further comprise:
receiving a third user input indicative that the determined location or the determined type are to be changed;
updating a determined location or a determined type; and
providing the updated determined location or the determined type.

20. A non-transitory computer readable memory storing instructions which, when executed by at least one data processor forming part of at least one computing system, causes the at least one data processor to perform operations comprising:
receiving a first set of data characterizing an image or video captured by a non-destructive testing device from within mechanical equipment during an inspection, and a second set of data characterizing an image recognition library that includes features of example mechanical equipment;
determining a presence of a feature based on the first set of received data and the second set of received data; and
providing an indication of a presence of the feature.
